(19) United States
(12) Patent Application Publication
(10) Pub. No.: US 2025/0243798 A1
(43) Pub. Date: Jul. 31, 2025

(54) HEAT MANAGEMENT DEVICE FOR VEHICLE

(71) Applicant: TOYOTA JIDOSHA KABUSHIKI KAISHA, Toyota-shi (JP)

(72) Inventor: Hideto MINEKAWA, Toyota-shi (JP)

(73) Assignee: TOYOTA JIDOSHA KABUSHIKI KAISHA, Toyota-shi (JP)

(21) Appl. No.: 18/903,169

(22) Filed: Oct. 1, 2024

(30) Foreign Application Priority Data
Jan. 31, 2024 (JP) 2024-012546

(51) Int. Cl. F01P 3/20; B60H 1/00; B60L 58/27; F01P 7/14

(52) U.S. Cl. CPC F01P 3/20; B60H 1/00278; B60H 1/004; B60L 58/27; F01P 7/14; F01P 2050/24; F01P 2060/08; F01P 2060/18

(57) ABSTRACT

When heating is requested during HV traveling, the four-way valve of the first circuit is switched to mode 1 (connecting P2 and P3), and the cooling liquid is circulated to the internal combustion engine and the heater core. When heating is requested during EV traveling, the four-way valve is switched to mode 2 (connecting P1 and P3), and heating is performed by using the heat of the electric heater. When switching from mode 1 to mode 2, after switching from mode 1 to mode 3 (connecting P1 and P4 and connecting P2 and P3), switching from mode 3 to mode 2 is performed. The low-temperature cooling liquid that has stayed in the flow path in mode 1 flows into the heater core in mode 2 after being heated by the internal combustion engine in mode 3, so that it is possible to suppress the heating capacity from being temporarily lowered.

### CROSS-REFERENCE TO RELATED APPLICATION

This application claims priority to Japanese Patent Application No. 2024-012546 filed on Jan. 31, 2024, incorporated herein by reference in its entirety.

### BACKGROUND

### 1. Technical Field

The present disclosure relates to a heat management device for a vehicle.

### 2. Description of Related Art

Japanese Unexamined Patent Application Publication No. 2009-291008 (JP 2009-291008 A) discloses a heat management system for an electric drive vehicle that includes a traveling electric motor driven by a battery and a selectively used traveling internal combustion engine. In the heat management system of JP 2009-291008 A, a cooling liquid of the internal combustion engine used as a heat source of a heater core of an air conditioning device (air conditioning device) is heated by using an electric heater. According to the configuration, heating of the air conditioning device can be performed by using heat of both the internal combustion engine and the electric heater.

### SUMMARY

In the heat management system of JP 2009-291008 A, the electric heater is provided in a heat medium circulation cycle (a flow path of the cooling liquid) that circulates in the internal combustion engine and the heater core. Therefore, when heating is performed by using heat of the electric heater, if the temperature of the internal combustion engine is low, heat of the electric heater is used for warming up the internal combustion engine, and there is a concern that heat of the electric heater cannot be efficiently used for heating. In order to efficiently use heat of the electric heater for heating, it is conceivable to provide a bypass flow path that bypasses the internal combustion engine, and to circulate the cooling liquid heated by the electric heater in the heater core via the bypass flow path.

The cooling liquid warmed by the internal combustion engine does not flow in the bypass flow path that bypasses the internal combustion engine. In a state where the cooling liquid of the internal combustion engine circulates in the heater core and heat of the internal combustion engine is set as a heat source of heating, the temperature of the cooling liquid that resides in the bypass flow path is low. From the state, when the cooling liquid heated by the electric heater circulates in the heater core via the bypass flow path, the cooling liquid with a low temperature that resides in the bypass flow path flows into the heater core, and therefore there is a concern that the heating capacity temporarily decreases.

The present disclosure suppresses a heating capacity from temporarily decreasing.

A heat management device for a vehicle according to the present disclosure is a heat management device for a vehicle that includes an internal combustion engine and a traveling electric motor, and is able to perform hybrid vehicle traveling with the internal combustion engine operating and electric vehicle traveling with the internal combustion engine stopped.

The heat management device includes an air conditioning device that includes a heater core for heating a vehicle cabin of the vehicle,
a first flow path that circulates a cooling liquid in the internal combustion engine and the heater core,
a second flow path that includes a bypass flow path that bypasses the internal combustion engine, the second flow path circulates the cooling liquid in a heat source different from the internal combustion engine and the heater core,
a third flow path that allows the cooling liquid flowing through the bypass flow path to flow into at least one of the internal combustion engine and the heat source by bypassing the heater core, and
a control device.
When the control device switches from the first flow path to the second flow path, the control device is configured to switch from the third flow path to the second flow path after switching from the first flow path to the third flow path.

According to the configuration, the vehicle can perform hybrid vehicle traveling that travels by operating the internal combustion engine and electric vehicle traveling that travels by stopping the internal combustion engine. The heat management device includes an air conditioning device that includes a heater core for heating a vehicle cabin of the vehicle, and a control device. The control device switches from a first flow path that circulates the cooling liquid in the internal combustion engine and the heater core to a second flow path that includes a bypass flow path that bypasses the internal combustion engine and circulates the cooling liquid in a heat source different from the internal combustion engine. At this time, the control device switches from the third flow path to the second flow path after switching from the first flow path to the third flow path that allows the cooling liquid flowing through the bypass flow path to flow into at least one of the internal combustion engine and the heat source by bypassing the heater core.

When heating of the vehicle cabin is performed by using the cooling liquid that circulates in the first flow path, since the cooling liquid warmed by the internal combustion engine does not flow in the bypass flow path that bypasses the internal combustion engine, the temperature of the cooling liquid that resides in the bypass flow path is low. When heating is performed by switching from the first flow path to the second flow path, the cooling liquid with a low temperature that resides in the bypass flow path flows into the heater core, and therefore there is a concern that a heating capacity temporarily decreases.

When the control device switches from the first flow path to the second flow path, the control device switches from the third flow path to the second flow path after switching from the first flow path to the third flow path. When switching to the third flow path is executed, the cooling liquid flowing through the bypass flow path flows into at least one of the internal combustion engine and the heat source by bypassing the heater core, and is warmed by at least one of the internal combustion engine and the heat source. Then, after the cooling liquid that resides in the bypass flow path is warmed, switching to the second flow path is executed. As a result, the cooling liquid with a low temperature that resides in the bypass flow path can be suppressed from flowing into the heater core, and a heating capacity can be suppressed from temporarily decreasing.

The heat management device may include

a battery being a power source of the traveling electric motor, and
a fourth flow path through which a heat medium circulates to raise the temperature of the battery.
The third flow path may allow the cooling liquid flowing through the bypass flow path to flow into the heat source via a heat exchanger provided in the fourth flow path.

According to the configuration, the flow path that raises the temperature of the battery by using the heat source, and the third flow path, can both be used.

Preferably, when there is a temperature rise request of the battery, the control device may circulate the heat medium of the fourth flow path and may circulate the cooling liquid of the third flow path, and may raise the temperature of the battery by using the heat source.

According to the configuration, when there is a temperature rise request of the battery, the control device circulates the heat medium of the fourth flow path and circulates the cooling liquid of the third flow path. By heating the cooling liquid that circulates in the third flow path by the heat source, since the heat medium raises the temperature by heat of the cooling liquid flowing through the bypass flow path via the heat exchanger, the temperature of the battery can be raised by using the heat source.

Preferably, the heat source may be an electric heater.

According to the configuration, since an electric heater is used, heating or a temperature rise of the battery can be executed, even in electric vehicle traveling that travels by stopping the internal combustion engine.

Preferably, the control device may control to circulate the cooling liquid in the first flow path when there is a heating request of the vehicle cabin during the hybrid vehicle traveling, and circulate the cooling liquid in the second flow path when there is the heating request during the electric vehicle traveling.

According to the configuration, heating can be performed by using heat of the internal combustion engine during hybrid vehicle traveling, and heating can be performed by using the heat source during electric vehicle traveling. When switching from hybrid vehicle traveling to electric vehicle traveling is performed, while switching from the first flow path to the second flow path is executed, switching from the third flow path to the second flow path is executed after switching from the first flow path to the third flow path is executed. Therefore, the cooling liquid with a low temperature that resides in the bypass flow path can be suppressed from flowing into the heater core, and a heating capacity can be suppressed from temporarily decreasing.

According to the present disclosure, the heating capacity can be suppressed from temporarily decreasing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a heat management device for a vehicle according to an embodiment of the present disclosure;

FIG. 2 is a diagram for explaining an example of a connection pattern of a four-way valve;

FIG. 3 is a diagram for explaining a circulation path of the cooling liquid in the mode 1;

FIG. 4 is a diagram illustrating a circulation path of the cooling liquid in the mode 3;

FIG. 5 is a diagram for explaining a circulation path of the cooling liquid in the mode 2; and

FIG. 6 is a flow chart illustrating an exemplary EV traveling requesting process executed by ECU.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

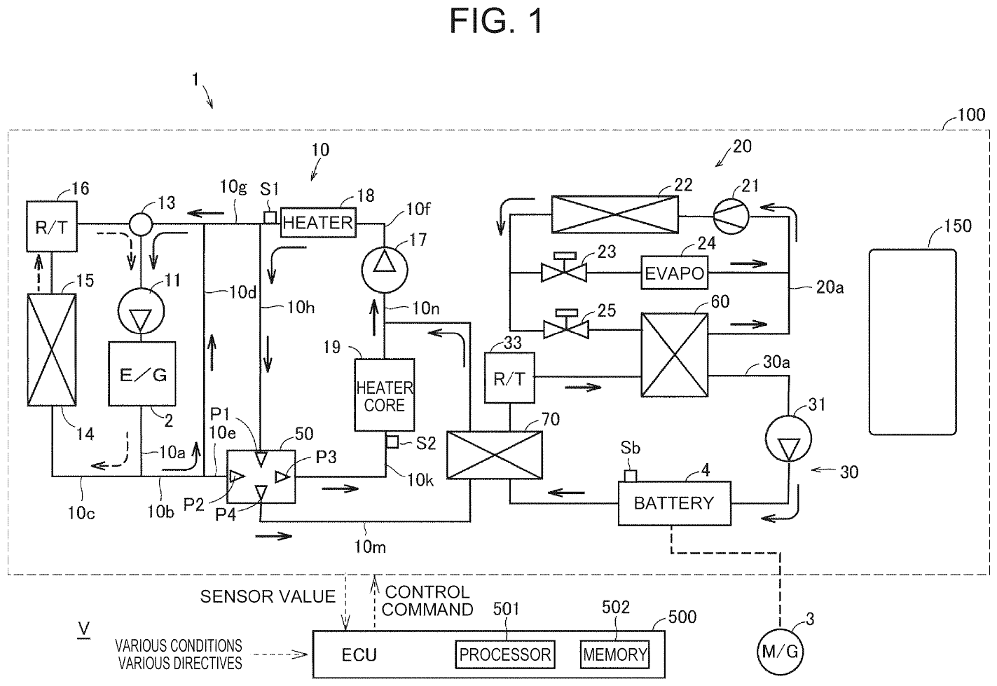

FIG. 1 is a diagram illustrating a schematic configuration of a heat management device of a vehicle according to this embodiment. Vehicle V is a hybrid electric vehicle including an internal combustion engine 2, a motor generator (MG) 3, and a battery 4. MG 3 may be, for example, an Interior Permanent Magnet (IPM) motor and is driven by electric power stored in the battery 4 or by electric power generated by the internal 30 combustion engine 2. MG 3 corresponds to an exemplary “traveling electric motor” of the present disclosure. The hybrid system of the vehicle V may be any of a series system, a parallel system, and a series/parallel system as long as the hybrid system is capable of HV traveling by operating the internal combustion engine 2 and EV traveling by stopping the internal combustion engine 2 and driving with MG 3 power. The number of MG may be one or a plurality. Further, the battery 4 may be an externally chargeable plug-in hybrid electric vehicle.

The heat management device 1 mounted on the vehicle V includes a heat management circuit 100 and an Electronic Control Unit (ECU) 500. ECU 500 includes a processor 501 and memories 502. The processor 501 executes the program stored in the memory 502 to execute various types of thermal control in ECU 500. ECU 500 corresponds to an exemplary “control device” of the present disclosure.

The heat management device 1 is configured to perform heat management of the vehicle V using the heat medium of the heat management circuit 100. The heat management circuit 100 includes a first circuit 10, a second circuit 20, and a third circuit 30. The first circuit 10 is a circuit in which a cooling liquid circulates, and includes an internal combustion engine 2, a first pump 11, a second pump 17, an electric heater 18, a heater core 19, and a four-way valve 50. The first pump 11 may be an electric pump or a mechanical pump driven by the internal combustion engine 2. The second pump may be an electric pump. The cooling liquid may be, for example, Long-Life Coolant (LLC) containing ethylene glycol. Referring to FIG. 1, after cooling the internal combustion engine 2, the cooling liquid discharged from the first pump 11 flows into the flow path 10a and branches into the flow path 10b and the flow path 10c. A radiator 15 and a reserve tank 16 are provided in the flow path 10c, and the reserve tank 16 is connected to the thermostat valve 13. The flow path 10b branches into a flow path 10d and a flow path 10e. The flow path 10d is connected to the thermostat valve 13 via a flow path 10g connecting the electric heater 18 and the thermostat valve 13. The flow path 10e is connected to the port P2 of the four-way valve 50.

When the temperature of the cooling liquid is equal to or lower than the predetermined temperature, the thermostat valve 13 is closed, and the cooling liquid discharged from the first pump 11 circulates through the flow path 10a, the flow path 10b, and the flow path 10g. When the temperature of the cooling liquid exceeds the predetermined temperature, the thermostat valve 13 opens, and the cooling liquid discharged from the first pump 11 flows to the flow path 10c and is cooled (radiated) by the radiator 15.

In the first circuit 10, the cooling liquid discharged from the second pump to the flow path 10f branches from the flow path 10g to the flow path 10h through the electric heaters 18. The flow path 10h is connected to the port P1 of the four-way valve 50.

The four-way valve 50 switches the path of the cooling liquid. The four-way valve 50 includes four ports P1 to P4. ECU 500 controls the four-way valve 50 so as to be one of the connecting patterns of the modes 1 to 5. Hereinafter, the ports P1, P2, P3, P4 may be simply referred to as “P1”, “P2”, “P3”, and “P4”, respectively.

The port P3 of the four-way valve 50 is connected to the flow path 10k. The flow path 10k is a flow path connecting the port P3 and the heater core 19. The heater core 19 is connected to the inlet of the second pump 17 by a flow path 10h. The heater core 19 is used as a heating source of the air conditioning device 150.

The port P4 of the four-way valve 50 is connected to the flow path 10m. The flow path 10m is connected to the flow path 10n connecting the heater core 19 and the second pump 17 through the heat exchanger 70.

The second circuit 20 is a refrigeration cycle, and the coolant circulates in the flow path 20a of the second circuit 20. The refrigerant may be, for example, a refrigerant such as hydrofluorocarbon (HFC), ammonia, carbon dioxide, etc. The second circuit 20 includes a compressor 21, a condenser 22, an electric expansion valve 23, an evaporator 24, an electric expansion valve 25, and a chiller 60. The compressor 21 adiabatically compresses and discharges the low-temperature and low-pressure refrigerant (mainly gas) flowing out of the evaporator 24 and the chiller 60. The condenser 22 cools the high-temperature and high-pressure refrigerant (mainly gas) discharged from the compressor 21 in an isobaric manner to convert the refrigerant into a high-temperature and high-pressure liquid refrigerant. At this time, the heat of the refrigerant is released (radiated) to the outside air. The high-temperature and high-pressure liquid refrigerant is reduced in pressure by the electric expansion valve 23, and thereby vaporizes and absorbs heat in the evaporator 24. In addition, the high-temperature and high-pressure liquid refrigerant is reduced in pressure by the electric expansion valve 25, thereby vaporizing and absorbing heat in the chiller 60. The evaporator 24 is used as a cooling source of the air conditioning device 150.

The third circuit 30 adjusts (cools and raises) the temperature of the battery 4. The heat medium circulates in the flow path 30a of the third circuit 30. The heating medium may be an insulating oil or an electrically insulating antifreeze. The third circuit 30 includes an electric pump 31, a battery 4, a heat exchanger 70, a reserve tank 33, and a chiller 60, and the heat medium discharged from the electric pump 31 circulates in the flow path 30a. The heat exchanger 70 exchanges heat between the cooling liquid flowing in the flow path 10m of the first circuit 10 and the heat medium flowing in the flow path 30a. The heat medium absorbs heat from the cooling liquid flowing through the flow path 10m, thereby raising the temperature of the battery 4. The chiller 60 exchanges heat between the refrigerant circulating in the second circuit 20 (refrigeration cycle) and the heat medium flowing in the third circuit 30. The heat medium cools the battery 4 by radiating heat in the chiller 60. The third circuit 30 (flow path 30a) corresponds to an exemplary “fourth flow path” of the present disclosure.

The air conditioning device 150 includes a blower, a damper, and the like, which are not shown, and performs cooling and heating in the vehicle cabin of the vehicle V. The heater core 19 of the first circuit 10 and the evaporator 24 of the second circuit 20 are provided downstream of the blower of the air conditioning device 150. The heater core 19 is used as a heating source of the air conditioning device 150, and the evaporator 24 is used as a cooling source of the air conditioning device 150.

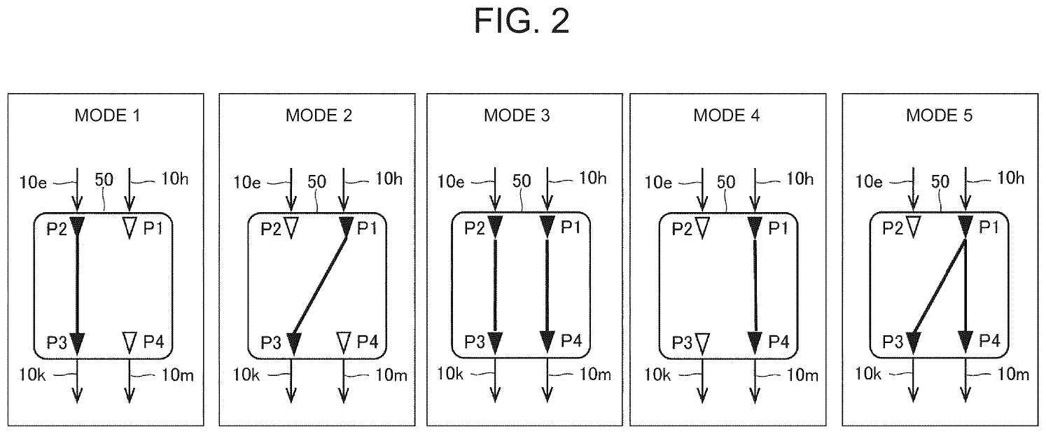

FIG. 2 is a diagram illustrating an example of a connection pattern of the four-way valve 50. As shown in FIG. 2, the connection pattern includes connection patterns of modes 1 to 5. In mode 1, P2 and P3 are connected, and P1 and P4 are disconnected. In mode 2, P1 and P3 are connected, and P2 and P4 are disconnected. In the third mode, P1 and P4 are connected, and P2 and P3 are connected. In mode 4, P1 and P4 are connected, and P2 and P3 are disconnected. In mode 5, P1 and P3 are connected, and P1 and P4 are connected, and P2 is unconnected.

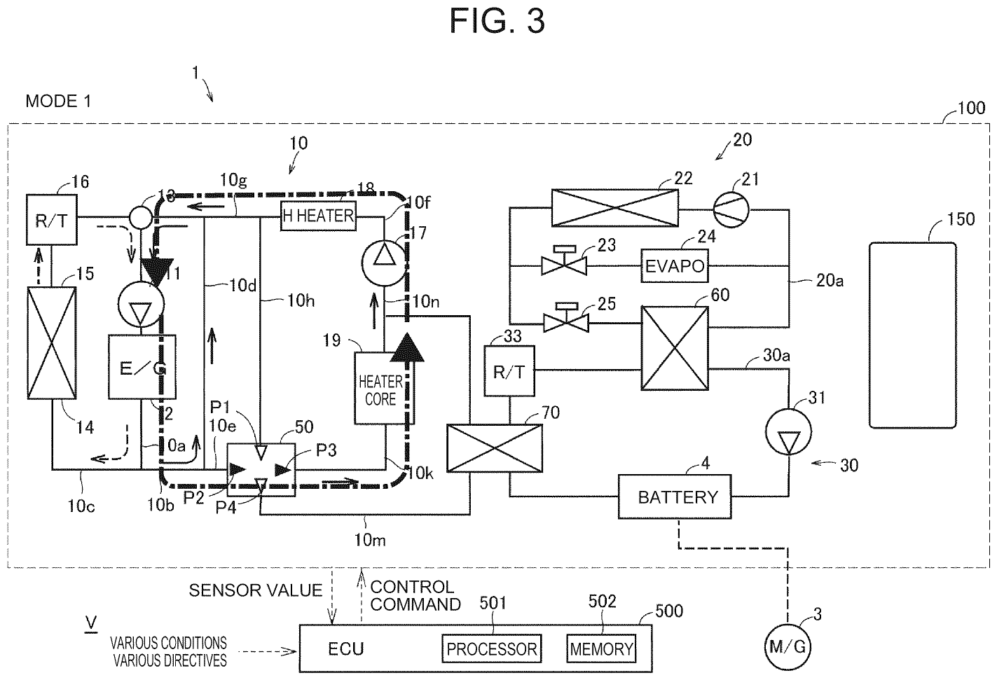

FIG. 3 is a diagram for explaining a circulation path of the cooling liquid in the mode 1. When the connection pattern of the four-way valve 50 is mode 1, the port P2 and the port P3 are connected, and the flow path 10e and the flow path 10k are connected. In the mode 1, as indicated by the dashed-dotted arrow in FIG. 3, the cooling liquid discharged from the first pump 11 flows into the heater core 19 after cooling the internal combustion engine 2 (after absorbing heat from the internal combustion engine 2). The cooling liquid flowing out of the heater core 19 returns to the inflow side (suction side) of the first pump 11 via the second pump 17 and the electric heater 18. At this time, the electric heater 18 is not energized. The second pump 17 may be operated in accordance with the flow rate of the cooling liquid. For example, if the flow rate of the cooling liquid is sufficient by the operation of the first pump, the second pump may be inactive, and if the flow rate by the first pump is insufficient, the second pump is activated. The second pump may be operated regardless of the flow rate of the cooling liquid. The circulation path of the cooling liquid in the mode 1 corresponds to an example of the “first flow path” of the present disclosure. In the mode 1, the heat of the cooling liquid warmed by the internal combustion engine 2 is dissipated by the heater core 19, so that the vehicle cabin can be heated.

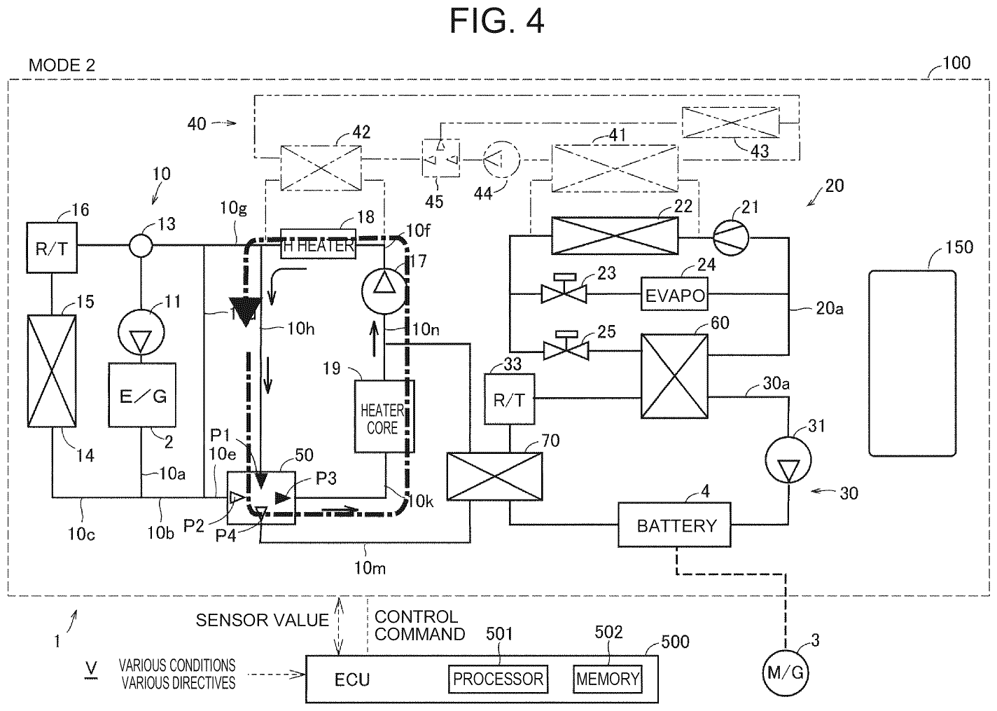

FIG. 4 is a diagram for explaining a circulation path of the cooling liquid in the mode 2. When the connection pattern of the four-way valve 50 is mode 2, the port P1 and the port P3 are connected, and the flow path 10h and the flow path 10k are connected. In the mode 2, as indicated by the dashed-dotted arrow in FIG. 4, the cooling liquid discharged from the second pump 17 is heated by the electric heater 18 and flows into the heater core 19 through the flow path 10h. The cooling liquid flowing out of the heater core 19 returns to the inflow side (suction side) of the second pump 17. At this time, the electric heater 18 is energized to heat the cooling liquid. The circulation path of the cooling liquid in the mode 2 corresponds to an example of the “second flow path” of the present disclosure. The flow path 10h corresponds to a “bypass flow path (bypass flow path bypassing the internal combustion engine)”. In the mode 2, the heat of the cooling liquid heated by the electric heater 18 is dissipated by the heater core 19, so that the vehicle cabin can be heated.

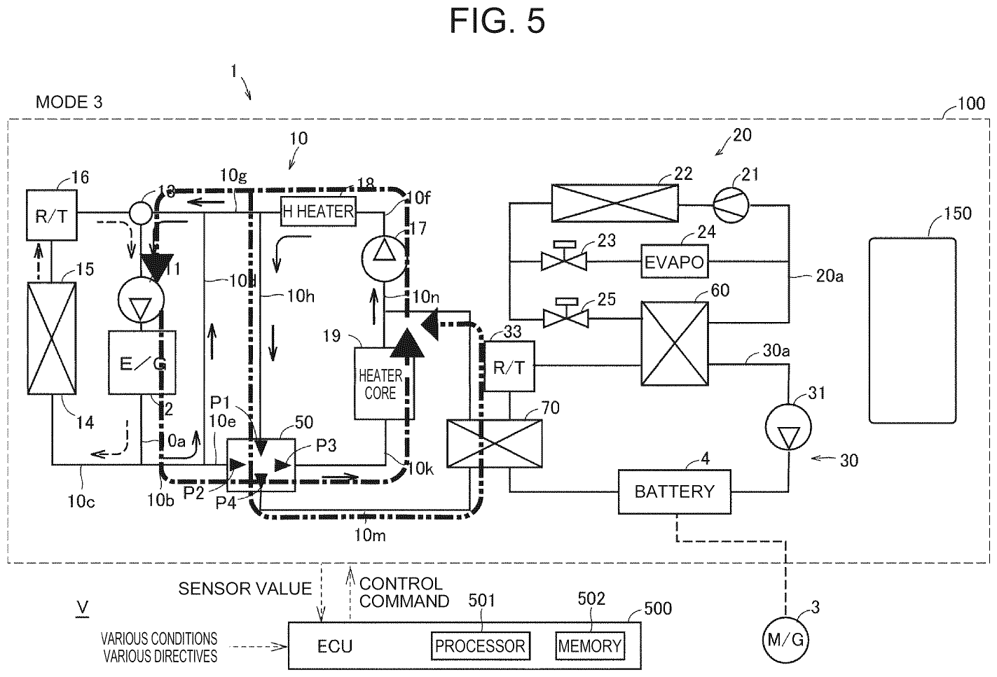

FIG. 5 is a diagram for explaining a circulation path of the cooling liquid in the mode 3. When the connecting pattern of the four-way valve 50 is mode 3, the port P2 and the port P3 are connected, and the port P1 and the port P4 are connected. The cooling liquid discharged from the first pump 11 flows into the heater core 19 after cooling the internal combustion engine 2, as indicated by an arrow indicated by a dashed-dotted line in FIG. 5, in which the port P2 and the port P3 are connected to each other and the flow path 10e and the flow path 10k are connected to each other. When the port P1 and the port P4 are connected to each other and the flow path 10h and the flow path 10m are connected to each other, the cooling liquid flowing through the flow path 10h flows through the flow path 10m as indicated by the arrow indicated by the two-dot chain line in FIG. 5. Then, the cooling liquid flows into the flow path 10n connecting the heater core 19 and the second pump 17 through the heat exchanger 70. In mode 3, both the first pump 11 and the second pump 17 may be activated, and either one of them may be activated. In mode 3, the electric heater 18 may be energized or de-energized. In this mode 3, the circulation path (the flow path including the flow path 10m) of the cooling liquid indicated by the two-dot chain arrows corresponds to an exemplary “third flow path” of the present disclosure.

ECU 500 receives the signals detected by the sensors provided in the heat management circuit 100, and controls the first circuit 10, the second circuit 20, and the third circuit. For example, when the battery temperature Tb detected by the battery temperature sensor Sb (see FIG. 1) is equal to or lower than a predetermined value, a temperature rise request of the battery 4 is generated, and the temperature rise control of the battery 4 is executed. The temperature rise request of the battery 4 may be generated by a battery ECU (not shown). ECU 500 switches the connection pattern of the four-way valve 50 to the mode 4 when there is a temperature rise request of the battery 4, and connects the port P1 and the port P4. Then, the second pump 17 is operated and the electric heater 18 is energized. In addition, the electric pump 31 is operated to circulate the heat medium of the third circuit 30. In the heat exchanger 70, the cooling liquid (the cooling liquid flowing through the flow path 10h) heated by the electric heater 18 exchanges heat with the heat medium of the third circuit 30, thereby raising the temperature of the battery 4. In addition to the temperature rise request of the battery 4, when there is a heating request of the air conditioning device 150, the connection pattern of the four-way valve 50 is switched to the mode 5.

In ECU 500, the status of the respective functions and various commands are inputted from an engine ECU, a hybrid ECU, an air conditioning ECU, and the like (none of which is shown). For example, when there is a heating request in the vehicle cabin while HV traveling by operating the internal combustion engine 2, ECU 500 switches the connecting pattern of the four-way valve 50 to the mode 1. As a result, the heat of the cooling liquid warmed by the internal combustion engine 2 can be dissipated by the heater core 19, and the vehicle cabin can be heated.

When there is a heating request in the vehicle cabin while the internal combustion engine 2 is stopped and is EV traveling by the power of MG 3, ECU 500 switches the connecting pattern of the four-way valve 50 to the mode 2. As a result, the heat of the cooling liquid heated by the electric heater 18 can be dissipated by the heater core 19, and the vehicle cabin can be heated.

During HV traveling, EV traveling is switched from HV traveling to EV traveling. At this time, if there is a heating request, the connection pattern of the four-way valve 50 is switched from mode 1 to mode 2. According to the mode 1, when heating is performed using the cooling liquid heated by the internal combustion engine 2, since the cooling liquid does not flow in the flow path 10h bypassing the internal combustion engine 2, the cooling liquid stays. Since the temperature of the cooling liquid staying in the flow path 10h is not warmed by the internal combustion engine 2, the temperature is lower. In this state (mode 1), when the mode 2 is switched, the cool cooling liquid staying in the flow path 10h (bypass flow path) flows into the heater core 19, which may temporarily reduce the heating capacity.

In the present embodiment, when the connection pattern of the four-way valve 50 is switched from the mode 1 to the mode 2, the connection pattern is switched from the mode 3 to the mode 2. When the connecting pattern of the four-way valve 50 is switched from mode 1 to mode 3, the port P1 and the port P4 are connected. Then, as indicated by the double-dashed arrow in FIG. 5, the cooling liquid flowing through the flow path 10h flows through the flow path 10m and flows into the flow path 10n connecting the heater core 19 and the second pump 17 through the heat exchanger 70. The cooling liquid flowing into the flow path 10n flows through the flow path e and the flow path 10k after being heated by the internal combustion engine 2, and flows into the heater core 19. In the third mode, when the electric heater 18 is energized, the cooling liquid flowing into the flow path 10n is heated by the electric heater 18 in addition to the internal combustion engine 2, and then flows into the heater core 19. As a result, the cooling liquid that has stayed in the flow path 10h (bypass flow path) flows into the heater core 19 after being heated by at least one of the internal combustion engine 2 and the heater core 19, and therefore the heating capacity can be suppressed from temporarily decreasing.

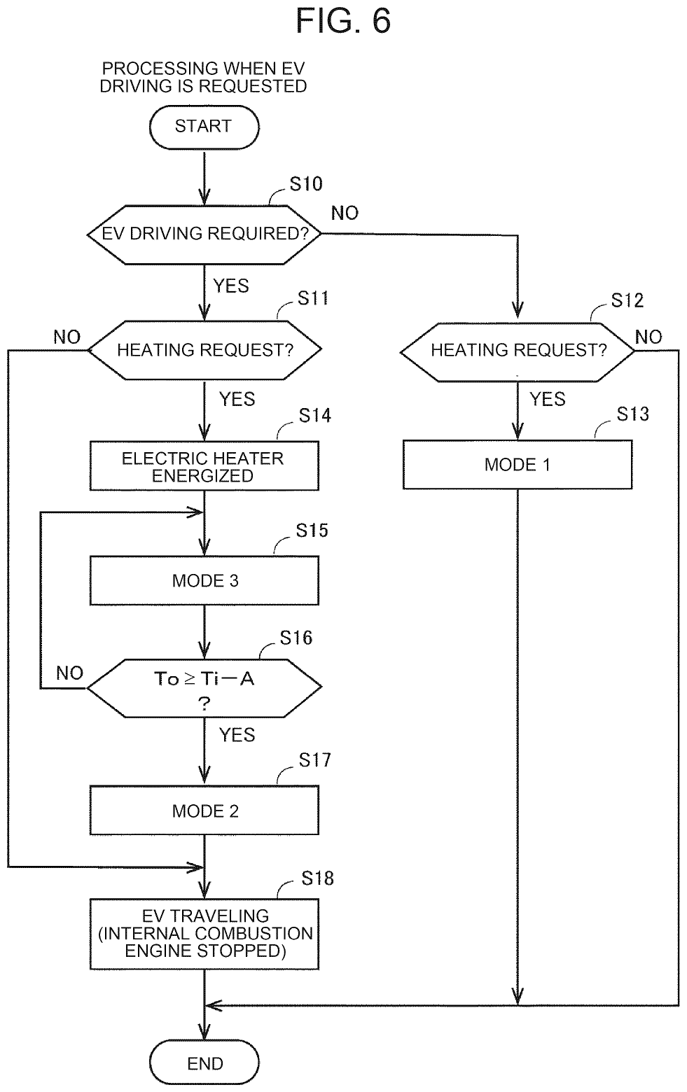

FIG. 6 is a flow chart illustrating an exemplary EV traveling requesting process executed by ECU 500. This flow chart is repeatedly processed at predetermined intervals during HV traveling of the vehicles V. In step (hereinafter, step is abbreviated as “S”) 10, it is determined whether or not there is a demand for EV traveling. EV traveling requirement is outputted from, for example, a hybrid-type ECU. If there is an EV traveling demand, an affirmative determination is made and the process proceeds to S11. If there is no EV traveling request, a negative determination is made and the process proceeds to S12.

S12 determines whether there is a heating request. The heating request is outputted, for example, from the air conditioning ECU. The heating request is a request for circulating the cooling liquid to the heater core 19. If there is a heating request, an affirmative determination is made and the process proceeds to S13. When there is no heating request, a negative determination is made, and the present routine is ended.

In S13, after the connecting pattern of the four-way valve 50 is switched to the mode 1, the present routine is ended. When the connection pattern of the four-way valve 50 is the mode 1, the mode 1 is maintained, and the present routine is ended.

S11 determines whether there is a heating request. If there is a heating request, an affirmative determination is made and the process proceeds to S14. When there is no heating request, a negative determination is made and the process proceeds to S18.

In S14, energization of the electric heaters 18 is started, and the process proceeds to S15. In S15, the connecting pattern of the four-way valve 50 is switched to the mode 3. Note that the process of S15, since it is a state of heating request, the connecting pattern of the four-way valve 50 is switched from mode 1 to mode 3.

In the following S16, it is determined whether or not the cooling liquid temperature To at the outlet (outflow side) of the electric heater 18 is equal to or higher than the threshold temperature “Ti-A” obtained by subtracting the predetermined value A from the cooling liquid temperature Ti at the inlet (inflow side) of the heater core 19. The cooling liquid temperature To may be detected by a temperature sensor S1 (see FIG. 1) provided at the outlet of the electric heater 18 in the flow path 10g, and the cooling liquid temperature Ti may be detected by a temperature sensor S2 (see FIG. 2) provided at the inlet of the heater core 19 in the flow path 10m. When the cooling liquid temperature To is lower than the threshold temperature “Ti-A” (To<Ti-A), a negative determination is made, and the process returns to S15. When the cooling liquid temperature To is equal to or higher than the threshold temperature “Ti-A” (Ti≥Ti-A), an affirmative determination is made and the process proceeds to S17.

In S17, after switching the connecting pattern of the four-way valve 50 to the mode 2, S18 proceeds. In S18, for example, a hybrid-type ECU is commanded to stop the internal combustion engine and perform EV traveling, and the present routine is terminated. As a result, the vehicle V performs EV traveling.

According to the present embodiment, the vehicles V are capable of HV traveling by operating the internal combustion engine 2 and EV traveling by stopping the internal combustion engine 2. The heat management device 1 of the vehicle V includes an air conditioning device 150 including a heater core 19 for heating the vehicle cabin of the vehicle V, and an ECU 500. ECU 500 includes a flow path 10m that bypasses the internal combustion engine 2 from the mode 1 in which the cooling liquid is circulated to the internal combustion engine 2 and the heater core 19, and switches to the mode 2 in which the cooling liquid is circulated to the electric heater 18 and the heater core 19, and switches from the mode 1 to the mode 3 in which the cooling liquid flowing in the flow path 10m flows into the internal combustion engine 2 and the electric heater 18 by bypassing the heater core 19, and then switches from the mode 3 to the mode 2. When switched to the mode 3, the cooling liquid flowing in the flow path 10h flows into at least one of the internal combustion engine 2 and the electric heater 18 bypassing the heater core 19, and is warmed by at least one of the internal combustion engine 2 and the electric heater 18. Thus, it is possible to suppress the low-temperature cooling liquid staying in the flow path 10h in the mode 1 flows into the heater core 19, temporarily heating capacity can be suppressed to decrease.

In the above embodiment, the electric heaters 18 are energized in S14 (see FIG. 6). However, when a highly responsive electric heater is employed as the electric heater 18, the electric heater 18 may be energized at the same time as the connecting pattern of the four-way valve 50 is switched to the mode 2 in S17.

In the above-described embodiment, when it is determined that the cooling liquid temperature To is equal to or higher than the threshold temperature “Ti-A” (Ti≥Ti-A), the connecting pattern of the four-way valve 50 is switched to the mode 2 (see S17, S18). However, the mode may be switched to the mode 2 when a predetermined time has elapsed after switching from the mode 1 to the mode 3. The predetermined time may be set to, for example, a time until the total amount of the cooling liquid that has stayed in the flow path 10h passes through the internal combustion engine 2.

In the above-described embodiment, the flow path 10m passing through the heat exchanger 70 is used as the “third flow path” of the present disclosure. However, a flow path may be provided that connects the port P4 of the four-way valve 50 and the flow path 10g (a flow path 10g connecting the electric heaters 18 and the thermostat valve 13). Then, the flow path may be used as the “third flow path” of the present disclosure, and the cooling liquid that has stayed in the flow path 10h (that has passed through the flow path 10h) may flow through the flow path. In this case, when the connecting pattern of the four-way valve 50 is the mode 3, the cooling liquid that has stayed in the flow path 10h (passed through the flow path 10h) is heated by the internal combustion engine 2.

### Modifications

In the above-described embodiment, the vehicle cabin is heated by using the electric heaters 18 during EV traveling, but in the modification, the heating is performed by using the heat dissipation (heat dissipation of the condenser 22) of the second circuit 20 (refrigeration cycle). Referring to FIG. 4, in a modification, a fourth circuit 40 indicated by a dashed-dotted line is used. In the fourth circuit 40, the heat exchanger 41 is provided in place of the condenser 22 of the second circuit, and the heat exchanger 42 is provided in place of the electric heater 18 of the first circuit 10. The fourth circuit 40 includes, in addition to the heat exchangers 41 and 42, an electric pump 44, a three-way valve 45, and a radiator 43.

The heat exchanger 41 absorbs heat generated when the high-temperature and high-pressure refrigerant discharged from the compressor 21 is isobarically cooled and changed to a liquid refrigerant to the heat medium of the fourth circuit 40. As a result, the heat medium of the fourth circuit 40 is heated. At the time of a heating request of the air conditioning device 150, the three-way valve 45 is switched so that the heat medium discharged from the electric pump 44 flows to the heat exchanger 42, and in the heat exchanger 42, the heat medium heated by the heat exchanger 41 and the cooling liquid of the first circuit 10 perform heat exchange. As a result, the temperature of the cooling liquid in the first circuit 10 rises, and heating can be performed. When there is no heating request, the three-way valve 45 is switched so that the heat medium discharged from the electric pump 44 flows to the radiator 43, and the radiator 43 radiates heat to the outside air.

In this modification, instead of the electric heater 18, heat dissipation of the second circuit 20 (heat dissipation of the condenser 22) can be used as a heat source for heating.

In the first circuit 10, a heat exchanger 42 may be provided in addition to the electric heater 18, and heat dissipation of the electric heater 18 and the second circuit 20 may be used as a heat source for heating.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A heat management device for a vehicle that includes an internal combustion engine and a traveling electric motor, and is able to perform hybrid vehicle traveling with the internal combustion engine operating and electric vehicle traveling with the internal combustion engine stopped, the heat management device comprising:
an air conditioning device that includes a heater core for heating a vehicle cabin of the vehicle;
a first flow path that circulates a cooling liquid in the internal combustion engine and the heater core;
a second flow path that includes a bypass flow path that bypasses the internal combustion engine, the second flow path circulates the cooling liquid in a heat source different from the internal combustion engine and the heater core;
a third flow path that allows the cooling liquid flowing through the bypass flow path to flow into at least one of the internal combustion engine and the heat source by bypassing the heater core; and
a control device, wherein when the control device switches from the first flow path to the second flow path, the control device is configured to switch from the third flow path to the second flow path after switching from the first flow path to the third flow path.

2. The heat management device according to claim 1, further comprising:
a battery being a power source of the traveling electric motor; and
a fourth flow path through which a heat medium circulates to raise a temperature of the battery, wherein the third flow path allows the cooling liquid flowing through the bypass flow path to flow into the heat source via a heat exchanger provided in the fourth flow path.

3. The heat management device according to claim 2, wherein when there is a temperature rise request of the battery, the control device circulates the heat medium of the fourth flow path and circulates the cooling liquid of the third flow path, and raises the temperature of the battery by using the heat source.

4. The heat management device according to claim 1, wherein the heat source is an electric heater.

5. The heat management device according to claim 1, wherein the control device controls to
circulate the cooling liquid in the first flow path when there is a heating request of the vehicle cabin during the hybrid vehicle traveling, and
circulate the cooling liquid in the second flow path when there is the heating request during the electric vehicle traveling.
